(19) United States
(12) Patent Application Publication
(10) Pub. No.: US 2026/0054640 A1
(43) Pub. Date: Feb. 26, 2026

(54) ROAD SURFACE DRAWING DEVICE

(71) Applicant: STANLEY ELECTRIC CO., LTD., Tokyo (JP)

(72) Inventors: Dianqi SONG, Tokyo (JP); Kanichi OKUMURA, Tokyo (JP); Kenichi SAITO, Tokyo (JP)

(21) Appl. No.: 19/304,420

(22) Filed: Aug. 19, 2025

(30) Foreign Application Priority Data
Aug. 22, 2024 (JP) 2024-140820

(51) Int. Cl. B60Q 1/50

(52) U.S. Cl. CPC B60Q 1/50; B60Q 2400/50

(57) ABSTRACT

A road surface drawing device includes a plurality of light-sources, a plurality of lens-bodies disposed so as to face the plurality of light-sources, respectively, and circuit-board on which the plurality of light-sources are mounted, wherein the plurality of light-sources are disposed to be aligned in vehicle-width-direction on same surface of the circuit-board, the plurality of lens-bodies are disposed such that each of distances between the plurality of lens-bodies and the plurality of light-sources which are facing their corresponding lens body sequentially decrease from one-side to other-side in the vehicle-width-direction, and lights emitted from the plurality of light-sources are projected toward road-surface through the plurality of lens-bodies, and therefore, when viewed the road-surface in a plan view, a plurality of drawing patterns are drawn to be aligned in a direction along an optical axis of light emitted from the light source which is positioned at one outermost side in the vehicle-width-direction.

### CROSS-REFERENCE TO RELATED APPLICATION

Priority is claimed on Japanese Patent Application No. 2024-140820, filed Aug. 22, 2024, the content of which is incorporated herein by reference.

### BACKGROUND OF THE INVENTION

### Field of the Invention

The present invention relates to a road surface drawing device.

### Description of Related Art

For example, some vehicles are configured to include a road surface drawing device that performs road surface drawing using light projected toward a road surface to improve safety during driving (see, for example, PCT International Publication No. WO 2022/168543).

Specifically, PCT International Publication No. WO 2022/168543 discloses a road surface drawing device that is configured to form a road surface drawing pattern drawn on a road surface, and the road surface drawing device includes a first light source unit having a first light source and a first optical component that refracts or reflects light emitted from the first light source, a second light source unit having a second light source and a second optical component that refracts or reflects light emitted from the second light source, and a projection lens that projects, in front of the road surface drawing device, the light emitted from the first light source and transmitted through the first optical component and the light emitted from the second light source and transmitted through the second optical component so as to form the road surface drawing pattern, wherein the first optical component and the second optical component are configured such that a first region illuminated by the first light source unit is located farther from the road surface drawing device than a second region illuminated by the second light source unit, and an equivalent light emitting area when the light emitted from the first light source is incident on the projection lens is smaller than an equivalent light emitting area when the light emitted from the second light source is incident on the projection lens.

### SUMMARY OF THE INVENTION

Incidentally, in the invention described in PCT International Publication No. WO 2022/168543, the above-described first light source unit and second light source unit are disposed to be aligned in a vertical direction (longitudinal direction) together with the projection lens. In a case of this configuration, a dimension in the vertical direction (longitudinal direction) becomes large. Also, since a relationship between each lens and the light source is determined by optical conditions, reducing the dimension in the vertical direction (longitudinal direction) to match a design results in sacrificing optical performance.

An aspect of the present invention provides a road surface drawing device suitable for performing road surface drawing.

An aspect of the present invention provides the following configuration.

[1] A road surface drawing device, which is mounted on a vehicle and which performs a road surface drawing from the vehicle toward a road surface, the road surface drawing device including a plurality of light sources, a plurality of lens bodies disposed so as to face the plurality of light sources, respectively, and a circuit board on which the plurality of light sources are mounted, wherein the plurality of light sources are disposed so as to be aligned in a vehicle width direction on a same surface of the circuit board, the plurality of lens bodies are disposed such that each of distances between the plurality of lens bodies and the plurality of light sources which are facing their corresponding lens body sequentially decrease from one side to other side in the vehicle width direction, a plurality of drawing patterns corresponding to each of the plurality of light sources are drawn to be aligned on the road surface by projecting lights emitted from the plurality of light sources toward the road surface through the plurality of lens bodies, and when viewed the road surface in a plan view, the plurality of drawing patterns are drawn to be aligned in a direction along an optical axis of light emitted from a light source which is positioned at one outermost side in the vehicle width direction.

[2] The road surface drawing device described in the above-described [1], in which, among the plurality of drawing patterns, a drawing pattern corresponding to a light source positioned on one side in the vehicle width direction may be projected farther in a direction in which the plurality of drawing patterns are aligned than a drawing pattern corresponding to a light source positioned on the other side in the vehicle width direction.

[3] The road surface drawing device described in the above-described [1], wherein the circuit board may be disposed in a state of being inclined forward with respect to the road surface.

[4] The road surface drawing device described in the above-described [1], wherein the optical axis of the light emitted from the light source positioned at one outermost side in the vehicle width direction and an optical axis of light projected by the lens body facing the light source may extend in a same direction.

[5] The road surface drawing device described in the above-described [1], in which the plurality of lens bodies may be configured such that, as the distance between the lens body and the facing light source increases, an outer shape of the lens body becomes relatively larger so that an incident surface of the lens body, into which the light emitted from the light source enters, becomes larger.

[6] The road surface drawing device described in the above-described [1], in which the plurality of lens bodies may be integrally formed.

According to the aspect of the present invention, a road surface drawing device suitable for performing road surface drawing is provided.

### BRIEF DESCRIPTION OF THE DRAWINGS

FIG. 1 is a plan view illustrating a state in which a plurality of drawing patterns are drawn on a road surface behind a vehicle using a road surface drawing device according to one embodiment of the present invention.

FIG. 2 is a perspective view illustrating a configuration of the road surface drawing device illustrated in FIG. 1.

FIG. 3 is a cross-sectional view of first, second, and third drawing units of the road surface drawing device along line III-III illustrated in FIG. 2, and a plan view schematically illustrating a plurality of drawing patterns drawn on a road surface by the first, second, and third drawing units.

FIG. 4A is a cross-sectional view of the first drawing unit of the road surface drawing device along line IVA-IVA illustrated in FIG. 2.

FIG. 4B is a cross-sectional view of the second drawing unit of the road surface drawing device along line IVC-IVC illustrated in FIG. 2.

FIG. 4C is a cross-sectional view of a third drawing unit of the road surface drawing device along line IVD-IVD illustrated in FIG. 2.

FIG. 5 is a plan view illustrating a state in which a plurality of drawing patterns are drawn on a road surface in front of the vehicle.

### DETAILED DESCRIPTION OF THE INVENTION

Hereinafter, an embodiment of the present invention will be described in detail with reference to the drawings.

Further, in the drawings used in the following description, in order to make each component easier to see, dimensional scales may be varied among components, and dimensional proportions or the like of the respective components may not necessarily correspond to those in actual ones.

Also, in the drawings illustrated below, an XYZ orthogonal coordinate system is set, in which an X-axis direction indicates a front-rear direction (length direction) of a vehicle B, a Y-axis direction indicates a left-right direction (width direction) of the vehicle B, and a Z-axis direction indicates a vertical direction (height direction) of the vehicle B.

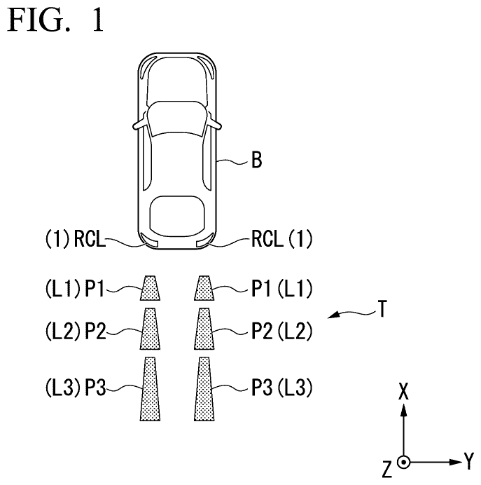

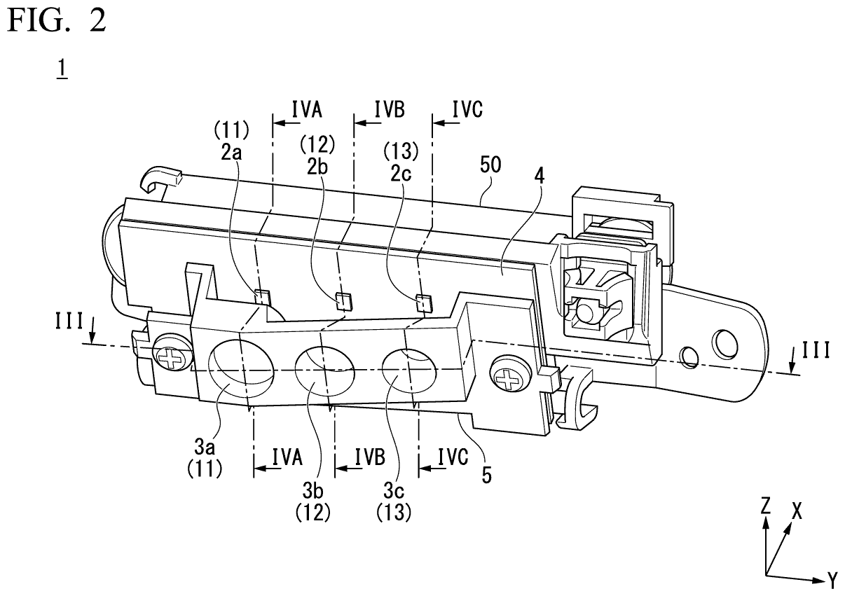

As one embodiment of the present invention, for example, a road surface drawing device 1 illustrated in FIGS. 1 to 4C will be described. Further, FIG. 1 is a plan view illustrating a state in which a plurality of drawing patterns P1, P2, and P3 are drawn on a road surface T behind the vehicle B using the road surface drawing device 1. FIG. 2 is a perspective view illustrating a configuration of the road surface drawing device 1.

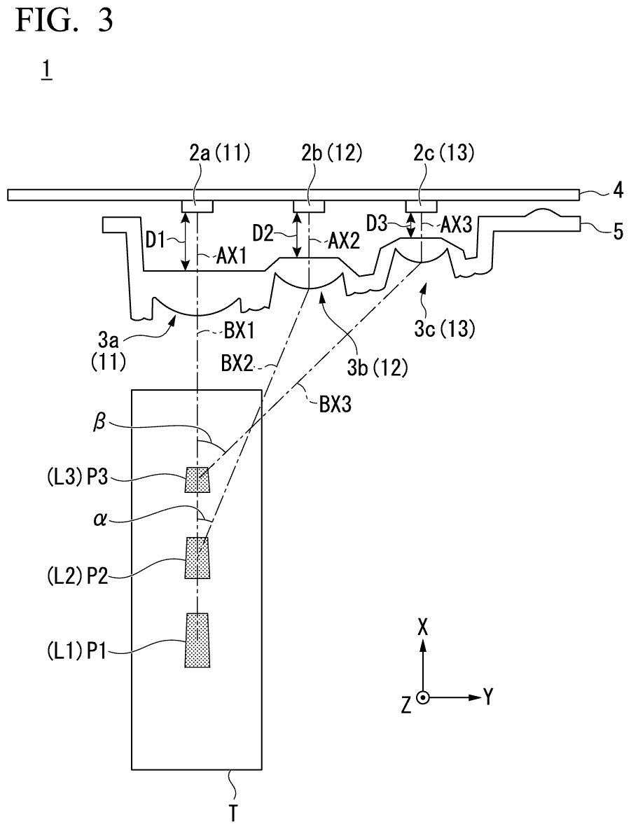

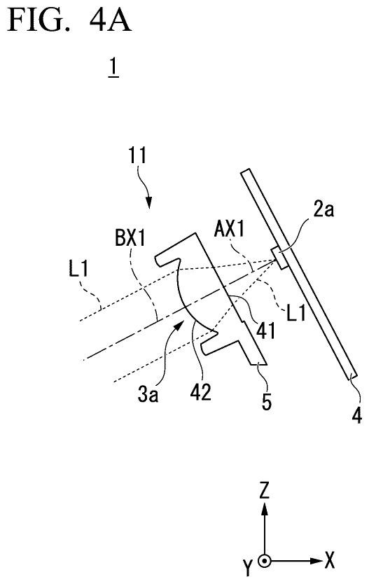

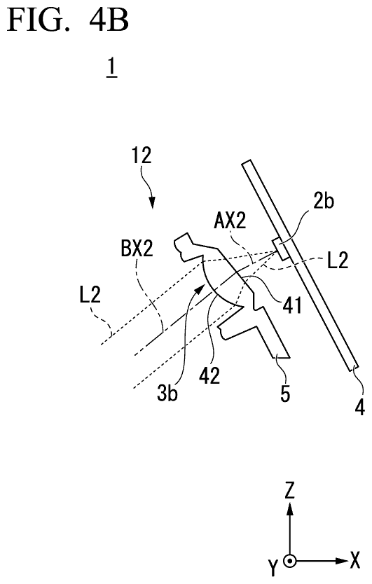

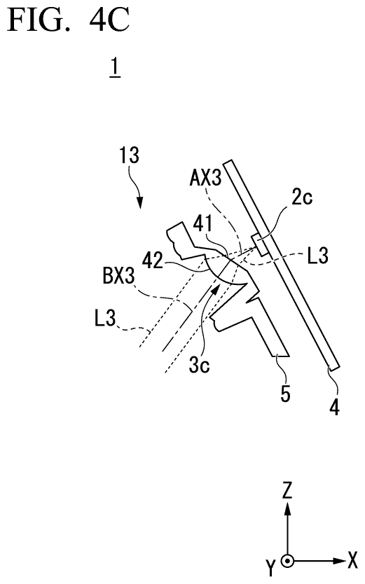

FIG. 3 is a cross-sectional view of first, second, and third drawing units 11, 12, and 13 of the road surface drawing device 1 along line III-III illustrated in FIG. 2, and a plan view schematically illustrating the plurality of drawing patterns P1, P2, and P3 drawn on the road surface T by the first, second, and third drawing units 11, 12, and 13. FIG. 4A is a cross-sectional view of the first drawing unit 11 of the road surface drawing device 1 along line IVA-IVA illustrated in FIG. 2. FIG. 4B is a cross-sectional view of the second drawing unit 12 of the road surface drawing device 1 along line IVB-IVB illustrated in FIG. 2. FIG. 4C is a cross-sectional view of the third drawing unit 13 of the road surface drawing device 1 along line IVC-IVC illustrated in FIG. 2.

The road surface drawing device 1 of the present embodiment is disposed inside a rear combination lamp RCL mounted on both corner portions on a rear end side of the vehicle B, for example, as illustrated in FIG. 1, and as part of a back lamp, projects a plurality of (three in the present embodiment) lights L1, L2, and L3 toward the road surface T behind the vehicle B when the vehicle B reverses, thereby drawing the plurality of (three in the present embodiment) drawing patterns P1, P2, and P3, which are aligned in the front-rear direction of the vehicle B, onto the road surface T.

Specifically, as illustrated in FIGS. 2 and 3, the road surface drawing device 1 includes a plurality of (three in the present embodiment) light sources 2a, 2b, and 2c, and a plurality of (three in the present embodiment) lens bodies 3a, 3b, and 3c disposed to face the plurality of light sources 2a, 2b, and 2c, respectively.

The road surface drawing device 1 of the present embodiment includes the plurality of (three in the present embodiment) drawing units 11, 12, and 13 that project the lights L1, L2, and L3 emitted from the light sources 2a, 2b, and 2c toward the road surface T behind the vehicle B through the lens bodies 3a, 3b, and 3c, and is configured such that the plurality of drawing units 11, 12, and 13 are disposed to be aligned in a width direction of the vehicle B (hereinafter referred to as a “vehicle width direction”).

In the present embodiment, the three drawing units 11, 12, and 13 are distinguished such that one positioned at one outermost side in the vehicle width direction (left side in FIG. 2) is referred to as the first drawing unit 11, one positioned in the middle in the vehicle width direction (middle in FIG. 2) is referred to as the second drawing unit 12, and one positioned at the other outermost side in the vehicle width direction (right side in FIG. 2) is referred to as the third drawing unit 13.

Therefore, the first drawing unit 11 is configured to include the light source 2a and the lens body 3a positioned at one outermost side in the vehicle width direction, the second drawing unit 12 is configured to include the light source 2b and the lens body 3b positioned in the middle in the vehicle width direction, and the third drawing unit 13 is configured to include the light source 2c and the lens body 3c positioned at the other outermost side in the vehicle width direction.

The plurality of light sources 2a, 2b, and 2c are formed of, for example, a light emitting element such as a light emitting diode (LED) or a laser diode (LD) that emits white light. The plurality of light sources 2a, 2b, and 2c are mounted on one surface (front surface) of a circuit board 4, and are disposed to be aligned in the vehicle width direction on the same surface of the circuit board 4.

Also, the circuit board 4 is disposed in a state of being inclined forward with respect to the road surface T. Thereby, the light sources 2a, 2b, and 2c radially emit lights L1, L2, and L3 obliquely downward in front of them (the rear of the vehicle B). Further, the circuit board 4 is held by a bracket 50 disposed on a rear side thereof.

The plurality of lens bodies 3a, 3b, and 3c are made of a light-transmissive member such as, for example, a transparent resin such as polycarbonate or acrylic, or glass. The road surface drawing device 1 of the present embodiment includes a lens member 5 in which the plurality of lens bodies 3a, 3b, and 3c are integrally formed, and the lens member 5 is disposed to face a front side of the circuit board 4. Also, the lens member 5 is attached to the bracket 50 by screws or the like.

Further, the lens bodies 3a, 3b, and 3c are not necessarily limited to being integrally formed by the lens member 5 described above, and may instead have a configuration in which they are disposed separately.

The plurality of lens bodies 3a, 3b, and 3c are disposed such that distances D1, D2, and D3 between the plurality of lens bodies 3a, 3b, and 3c and the plurality of light sources 2a, 2b, and 2c, which are facing their corresponding lens bodies 3a, 3b, and 3c, decrease sequentially from one side to the other side in the vehicle width direction.

Specifically, in the present embodiment, when a distance between the light source 2a and the lens body 3a, which face each other and are positioned at one outermost side in the vehicle width direction, is defined as D1, a distance between the light source 2b and the lens body 3b, which face each other and positioned in the middle in the vehicle width direction, is defined as D2, and a distance between the light source 2c and the lens body 3c, which face each other and positioned at the other outermost side in the vehicle width direction, is defined as D3, a relationship D1>D2>D3 is satisfied. Also, the lens bodies 3a, 3b, and 3c are formed of convex lenses, with the respective distances D1, D2, and D3 being adjusted so that a rear focal point of each of the lens bodies 3a, 3b, and 3c coincides with a light-emitting point of the corresponding light sources 2a, 2b, or 2c.

Specifically, each of the lens bodies 3a, 3b, and 3c has a flat incident surface 41 positioned on a side facing the respective light sources 2a, 2b, and 2c, and a convexly curved emission surface 42 positioned on a side opposite to the incident surface 41.

Each of the lens bodies 3a, 3b, and 3c receives each of the lights L1, L2, and L3 radially emitted from each of the light sources 2a, 2b, and 2c through each of the incident surfaces 41, and then emits the light to the outside through each of the emission surface 42 while collimating (making parallel) the light to be parallel with respect to optical axes AX1, AX2, and AX3 of the lights L1, L2, and L3 emitted from each of the light sources 2a, 2b, and 2c.

Also, outer shapes of the plurality of lens bodies 3a, 3b, and 3c are made relatively larger such that the incident surfaces 41, on which the lights L1, L2, and L3 emitted from the light sources 2a, 2b, and 2c are incident, become larger as the distances D1, D2, and D3 between the lens bodies 3a, 3b, and 3c and the facing light sources 2a, 2b, and 2c increase. Thereby, in the plurality of lens bodies 3a, 3b, and 3c, as the distances D1, D2, and D3 between the lens bodies and the facing light sources 2a, 2b, and 2c increase, amounts of incident lights L1, L2, and L3 emitted from the light sources increase, and the lights L1, L2, and L3 from the light sources 2a, 2b, and 2c can be projected farther.

In the road surface drawing device 1 of the present embodiment, in the first drawing unit 11, the optical axis AX1 of the light L1, which is emitted from the light source 2a positioned at one outermost side in the vehicle width direction, and an optical axis BX1 of the light L1, which is projected from the lens body 3a facing the light source 2a, extend in the same direction in an XY cross section illustrated in FIG. 3 and an XZ cross section illustrated in FIG. 4A.

On the other hand, in the second drawing unit 12, with respect to the optical axis AX2 of the light L2 emitted from the light source 2b positioned in the middle in the vehicle width direction, an optical axis BX2 of the light L2 projected from the lens body 3b facing the light source 2b is inclined toward one side in the vehicle width direction in the XY cross section illustrated in FIG. 3 and is inclined obliquely downward in the XZ cross section illustrated in FIG. 4B.

On the other hand, in the third drawing unit 13, with respect to the optical axis AX3 of the light L3 emitted from the light source 2c positioned at the other outermost side in the vehicle width direction, an optical axis BX3 of the light L3 projected from the lens body 3c facing the light source 2c is inclined toward one side in the vehicle width direction in the XY cross section illustrated in FIG. 3 and is inclined obliquely downward in the XZ cross section illustrated in FIG. 4C.

Also, in the second and third drawing units 12 and 13 illustrated in FIGS. 3, 4B, and 4C, the optical axis BX3 of the light L3 projected from the lens body 3c, which is positioned at the other outermost side in the vehicle width direction, is inclined at a greater angle than the optical axis BX2 of the light L2 projected from the lens body 3b, which is positioned in the middle in the vehicle width direction, toward one side in the vehicle width direction and obliquely downward.

In the road surface drawing device 1 of the present embodiment having the configuration as described above, as illustrated in FIG. 2, the lights L1, L2, and L3 emitted from the plurality of light sources 2a, 2b, and 2c are projected toward the road surface T behind the vehicle B by the plurality of lens bodies 3a, 3b, and 3c.

Thereby, on the road surface T behind the vehicle B, the drawing patterns P1, P2, and P3, which reflect shapes (for example, rectangular shapes) formed by the light emitted by each of the light sources 2a, 2b, and 2c, are projected to be aligned rearward on the road surface T as the rectangular drawing patterns P1, P2, and P3 extending toward the rear of the vehicle B and gradually increasing in width.

Further, shapes of each of the drawing patterns P1, P2, and P3 can also be rhombus shapes extending rearward on the road surface T depending on an orientation within the plane on which the light sources 2a, 2b, and 2c are disposed. Also, the shapes of the drawing patterns P1, P2, and P3 can be appropriately changed by changing light emission shapes of each of the light sources 2a, 2b, and 2c or by disposing light-shielding members (shades) in front of each of the light sources 2a, 2b, and 2c.

Also, in the road surface drawing device 1 of the present embodiment, in a plan view of the road surface T, the plurality of drawing patterns P1, P2, and P3 are drawn to be aligned in a direction along the optical axis AX1 of the light L emitted from the light source 2a positioned at one outermost side in the vehicle width direction.

Further, in the road surface drawing device 1 of the present embodiment, among the plurality of drawing patterns P1, P2, and P3, the drawing pattern corresponding to the light source positioned on one side in the vehicle width direction is drawn farther in a direction in which the plurality of drawing patterns P1, P2, and P3 are aligned than the drawing pattern corresponding to the light source positioned on the other side of the vehicle width direction.

Specifically, in the present embodiment, among the plurality of drawing patterns P1, P2, and P3, the drawing pattern P1 formed by the first drawing unit 11 positioned at one outermost side in the vehicle width direction is drawn farther in the direction in which the plurality of drawing patterns P1, P2, and P3 are aligned than the drawing pattern P2 formed by the second drawing unit 12 positioned in the middle in the vehicle width direction, and the drawing pattern P2 formed by the second drawing unit 12 positioned in the middle in the vehicle width direction is drawn farther in the direction in which the plurality of drawing patterns P1, P2, and P3 are aligned than the drawing pattern P3 formed by the third drawing unit 13 positioned at the other outermost side in the vehicle width direction.

Further, since distances of the lights L1, L2, and L3 projected from the plurality of drawing units 11, 12, and 13 toward the road surface T are sufficiently larger than intervals between adjacent ones of the plurality of drawing units 11, 12, and 13 aligned in the vehicle width direction, any deviation in centers of the plurality of drawing patterns P1, P2, and P3 in the vehicle width direction can be substantially ignored.

In the road surface drawing device 1 of the present embodiment, when the vehicle B reverses as illustrated in FIG. 1 described above, the plurality of drawing patterns P1, P2, and P3 are drawn to be aligned on the road surface T behind the vehicle B, making it possible to alert pedestrians and the like positioned behind vehicle B that vehicle B Is reversing.

Also, in the road surface drawing device 1 of the present embodiment, when the vehicle B reverses, it is also possible to perform road surface drawing that creates a flow of light emission using the plurality of drawing patterns P1, P2, and P3 by repeatedly performing a lighting operation in which the plurality of drawing units 11, 12, and 13 are sequentially turned on toward the road surface T while lighting of the plurality of drawing units 11, 12, and 13 is sequentially switched.

As for the lighting operation of sequentially lighting the plurality of drawing patterns P1, P2, and P3, examples thereof include a method of repeating an operation in which, from a state in which all the lights are off, the plurality of drawing patterns P1, P2, and P3 are sequentially and alternately turned on one by one toward the rear, and then all the lights are turned off, and a method of repeating an operation in which, from a state in which all the lights are off, the plurality of drawing patterns P1, P2, and P3 are sequentially added and turned on one by one toward the rear until all are lit, and then all the lights are turned off.

Incidentally, when the plurality of drawing patterns P1, P2, and P3 are projected to be aligned toward the rear of the vehicle B from the plurality of drawing units 11, 12, and 13 aligned in the vehicle width direction as described above, the drawing pattern P1 projected farthest is likely to be subject to blurring or distortion.

In contrast, in the road surface drawing device 1 of the present embodiment, as illustrated in FIGS. 3 and 4A, in a plan view of the road surface T, the plurality of drawing patterns P1, P2, and P3 are drawn to be aligned in a direction along the optical axis AX1 of the light L1 emitted from the light source 2a, which is positioned at one outermost side in the vehicle width direction, and a direction of the optical axis AX1 of the light L1 emitted from the light source 2a, which is positioned at one outermost side in the vehicle width direction, is made to coincide with a direction of the optical axis BX1 of the light L1 projected from the lens body 3a which is facing this light source 2a.

Thereby, blurring or distortion occurring in the drawing pattern P1, which is projected farthest by the first drawing unit 11, is suppressed. Also, since an output of the first drawing unit 11, which projects the drawing pattern P1 farthest, is the largest, the first drawing unit 11 is positioned at an outermost end in the vehicle width direction so as not to affect the remaining second and third drawing units 12 and 13 with the heat it generates.

Also, in the road surface drawing device 1 of the present embodiment, the distances D1, D2, and D3 between the light sources 2a, 2b, and 2c and the lens bodies 3a, 3b, and 3c, which face each other and constitute the respective drawing units 11, 12, and 13, and sizes of the lens bodies 3a, 3b, and 3c are adjusted so that, among the above-described plurality of drawing patterns P1, P2, and P3, the drawing pattern corresponding to the light source positioned on one side in the vehicle width direction is projected farther in a direction in which the plurality of drawing patterns P1, P2, and P3 are aligned than the drawing pattern corresponding to the light source positioned on the other side in the vehicle width direction.

In this case, as illustrated in FIG. 3, an inclination angle α of the optical axis BX2 of the light L2 projected from the second drawing unit 12 and an inclination angle β of the optical axis BX3 of the light L3 projected from the third drawing unit 13 with respect to the optical axis BX1 of the light L1 projected farthest from the first drawing unit 11 become larger as they are positioned farther toward the other side in the vehicle width direction from the first drawing unit 11 (α<β).

In contrast, in the road surface drawing device 1 of the present embodiment, since the drawing pattern P3 from the third drawing unit 13, which has the largest inclination angle β of the optical axis BX3 described above, is drawn at a nearest position, the influence of the inclination of the optical axis BX3 is reduced, thereby suppressing occurrence of blurring or distortion in the drawing pattern P3.

In this way, in the road surface drawing device 1 of the present embodiment, when the plurality of drawing patterns P1, P2, and P3 are drawn to be aligned toward the road surface T behind the vehicle B from the plurality of drawing units 11, 12, and 13 aligned in the vehicle width direction as described above, the drawing of the plurality of drawing patterns P1, P2, and P3 on the road surface can be appropriately performed.

Further, the present invention is not necessarily limited to the above-described embodiment, and various modifications can be made within a range not departing from the scope of the present invention.

For example, the road surface drawing device 1 described above may be configured not only to be disposed inside the rear combination lamp, but also to be disposed separately from the rear combination lamp or to be disposed in a rear bumper or the like.

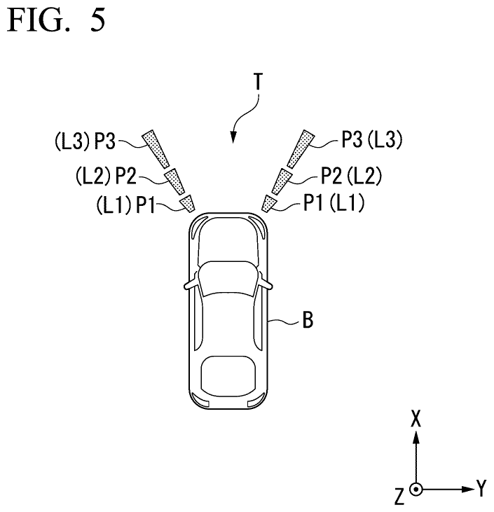

Also, in the above-described embodiment, as illustrated in FIG. 1, a case of drawing, as part of the backup lamp, the plurality of drawing patterns P1, P2, and P3 formed by white light emitted toward the road surface T behind the vehicle B when the vehicle B is reversing is illustrated as an example. On the other hand, as illustrated in FIG. 5, the road surface drawing device of the present invention can also be applied to a case of drawing, as part of turn lamps mounted on both corner portions at a front end side of the vehicle B, a plurality of drawing patterns P1, P2, and P3 formed by orange light emitted toward the road surface T obliquely forward on a turning side of the vehicle B when the vehicle B is turning.

Thereby, in a situation assuming a turning-related accident involving the vehicle B, for example, when turning at an intersection, it is possible to alert motorcycles, pedestrians, and the like located in blind spots of the vehicle B that the vehicle B is about to turn by means of the plurality of drawing patterns P1, P2, and P3 drawn on the road surface T when the turn lamp is lit.

While preferred embodiments of the invention have been described and illustrated above, it should be understood that these are exemplary of the invention and are not to be considered as limiting. Additions, omissions, substitutions, and other modifications can be made without departing from the scope of the present invention.

Accordingly, the invention is not to be considered as being limited by the foregoing description, and is only limited by the scope of the appended claims.

What is claimed is:

1. A road surface drawing device which is mounted on a vehicle and which performs a road surface drawing from the vehicle toward a road surface, the road surface drawing device comprising:
a plurality of light sources;
a plurality of lens bodies disposed so as to face the plurality of light sources, respectively; and
a circuit board on which the plurality of light sources are mounted,
wherein the plurality of light sources are disposed so as to be aligned in a vehicle width direction on a same surface of the circuit board,
the plurality of lens bodies are disposed such that each of distances between the plurality of lens bodies and the plurality of light sources which are facing their corresponding lens body sequentially decrease from one side to other side in the vehicle width direction,
a plurality of drawing patterns corresponding to each of the plurality of light sources are drawn to be aligned on the road surface by projecting lights emitted from the plurality of light sources toward the road surface through the plurality of lens bodies, and
when viewed the road surface in a plan view, the plurality of drawing patterns are drawn to be aligned in a direction along an optical axis of light emitted from a light source which is positioned at one outermost side in the vehicle width direction.

2. The road surface drawing device according to claim 1, wherein, among the plurality of drawing patterns, a drawing pattern corresponding to a light source positioned on one side in the vehicle width direction is projected farther in a direction in which the plurality of drawing patterns are aligned than a drawing pattern corresponding to a light source positioned on the other side in the vehicle width direction.

3. The road surface drawing device according to claim 1, wherein, the circuit board is disposed in a state of being inclined forward with respect to the road surface.

4. The road surface drawing device according to claim 1, wherein, the optical axis of the light emitted from the light source positioned at one outermost side in the vehicle width direction and an optical axis of light projected by the lens body facing the light source extend in a same direction.

5. The road surface drawing device according to claim 1, wherein, the plurality of lens bodies are configured such that, as the distance between the lens body and the facing light source increases, an outer shape of the lens body becomes relatively larger so that an incident surface of the lens body, into which the light emitted from the light source enters, becomes larger.

6. The road surface drawing device according to claim 1, wherein the plurality of lens bodies are integrally formed.
